(19) United States
(12) Patent Application Publication
(10) Pub. No.: US 2003/0056887 A1
(43) Pub. Date: Mar. 27, 2003

(54) Apparatus and methods for forming curved laminations

(76) Inventor: Philip Sicola, Gardena, CA (US)

Correspondence Address: David A. Belasco, Esq., BEEHLER & PAVITT, Suite 330, 100 Corporate Pointe, Culver City, CA, 90230, US

(21) Appl. No.: 09/964,984

(22) Filed: Sep. 26, 2001

(51) Int. Cl. B29C 47/00; B29C 65/00

(52) U.S. Cl. 156/212; 156/285; 156/245; 156/500

(57) ABSTRACT

An apparatus for forming curved laminations includes a first die board, which has a planar lower surface, a first curved upper surface and a first predetermined thickness. A plurality of lamination support members have parallel or unparallel top and bottom surfaces, first and second sides, first and second ends and a second predetermined thickness. When the planar lower surface of the first die board is located upon a horizontal surface and the support members are located upon the first curved upper surface of the first die board with the bottom surface adjacent the second end of the support members located upon the horizontal surface, the top surfaces of the support members will provide a curved surface for laminating veneer portions. A second die board has a planar lower surface and a second curved upper surface. When the lower surfaces of the die boards are located upon the horizontal surface and the support members are located upon the curved upper surfaces of the die boards, the top surfaces of the support members will provide a curved surface for laminating veneer portions. The support members may be notched to fit over the die boards. The notches may include downward facing curves to allow the support members to more accurately match the upper curves of the die boards. The top surfaces of the support members may include upward facing curves to minimize contact with veneer portions. An insulating sheet is placed between the upper surfaces of the support members and the veneer portions.

### FIELD OF INVENTION

The invention pertains to means for forming curved laminations. More particularly, the invention relates to adjustable and reusable tools and methods for producing building materials incorporating uniform, reproducible curved surfaces from laminated components.

### BACKGROUND OF THE INVENTION

Various types of tools and techniques have been developed for producing building materials having curved surfaces. U.S. Pat. No. 3,444,568, issued to Lerner is directed to a lattice core/foundation for boat hulls. The lattice is formed using lateral members or strips and cross pieces that are positioned approximately normal to each other and mechanically locked together at points of intersection. The patent provides for the structure to have curves in which lay-ups or laminations may be applied.

U.S. Pat. No. 5,106,290, issued to Carver et al., is directed to an assembly data model tool system. The invention provides for a surface that includes a plurality of profile boards and at least one connecting board. The profile edges of the profile boards define the surface of the tool. A series of curved profile boards attach to connector boards to form a curved surface over which laminations may be assembled.

U.S. Pat. No. 4,578,303, issued to Kundinger et al. describes a construction technique that involves preparation of an interleaved lattice structure or similar multi-level support structure over which a covering material is permanently installed. The curvature of the resulting construction is a result of this support structure.

U.S. Pat. No. 5,150,507 issued to Goela et al. uses an interleaved, notched construction to produce flat or curved honeycomb structures. The interleaved ribs are coated with a SiC material to form a monolithic structure.

U.S. Pat. No. 4,471,710 issued to Brown patent is directed to a method of manufacturing and applications of a building panel having a compound or complex curvature. The curved members are connected together by longitudinal members providing for a curved surface that is made from a plurality of strips of building material.

While other variations exist, the above-described inventions for forming curved laminations are typical of those encountered in the prior art. It is an objective of the present invention to provide a means for forming curved laminations that is repeatable and that can be preformed with a minimum of custom work. It is a further objective to provide a system for producing such laminations that includes standardized components that may be reused to produce laminations of differing curvature. It is a still further objective of the invention to provide means for producing laminations having base curves that differ from one end to the other. It is yet a further objective to provide means to produce laminations having surface curved in more than one plane.

While some of the objectives of the present invention are disclosed in the prior art, none of the inventions found include all of the requirements identified.

### SUMMARY OF THE INVENTION

The present invention addresses all of the deficiencies of prior art apparatus and methods for forming curved laminations and satisfies all of the objectives described above.

An apparatus for forming curved laminations providing the desired features may be constructed from the following components. A planar horizontal surface is provided, as is a first die board. The first die board has a planar lower surface, a first curved upper surface, a first predetermined thickness, first and second sides and first and second ends. A plurality of lamination support members is provided. The support members have parallel top and bottom surfaces, first and second sides, first and second ends and a second predetermined thickness.

When the planar lower surface of the first die board is located upon the horizontal surface and the lamination support members are located upon the first curved upper surface of the first die board with the bottom surface adjacent the second end of the lamination support members located upon the horizontal surface, the top surfaces of the lamination support members will reflect the first curved upper surface of the first die board above a point where the lamination support members contact the first upper surface and provide a curved surface for laminating veneer portions.

In a variant of the invention, a second die board is provided. The second die board has a planar lower surface, a second curved upper surface, a third predetermined thickness, first and second sides and first and second ends. When the planar lower surfaces of the first and second die boards are located upon the horizontal surface and the lamination support members are located upon the first and second curved upper surfaces of the first and second die boards, the top surfaces of the lamination support members will reflect the first and second curved upper surfaces of the first and second die boards and provide a curved surface for laminating veneer portions.

In a further variant, the lamination support members are cylindrical in cross-section. In still a further variant, the lamination support members are substantially rectangular in cross-section. The first side of the lamination support member includes a rounded projecting tongue and the second side of the lamination support member includes a mating rounded, receiving notch. Adjacent lamination support members will fit more closely together while following the first curved upper surface of the first die board, thereby forming a smoother surface upon which veneer portions are laminated.

In another variant of the invention, an insulating sheet is provided. The insulating sheet is formed of thin, flexible, resilient material. The insulating sheet is located between top surfaces of the lamination support members and a lower surface of a veneer portion being laminated upon the lamination support members. When the insulating sheet is inserted between the lamination support members and the lower surface of a veneer portion indentations in a lamination resulting from contact with top surfaces of the lamination support members will be minimized.

In still another variant, a planar horizontal surface is provided, as is a first die board. The first die board has a planar lower surface, a first curved upper surface, a first predetermined thickness, first and second sides and first and second ends. A plurality of lamination support members is provided. The support members have parallel top and bottom surfaces, first and second sides, first and second ends, a fourth predetermined thickness and a first notch located upon the bottom surface and spaced inwardly from the first end. The first notch has first and second side walls and a first upper bearing surface. The first notch is sized and shaped to fit slidably over the first predetermined thickness of the first die board.

When the planar lower surface of the first die board is located upon the horizontal surface and the first notches of the lamination support members are located upon the first curved upper surface of the first die board with the bottom surface adjacent the second end of the lamination support members located upon the horizontal surface, the top surfaces of the lamination support members will reflect the first curved upper surface of the first die board above a point where the first notches contact the first upper surface and provide a curved surface for laminating veneer portions.

In yet another variant, a second die board is provided. The second die board has a planar lower surface, a second curved upper surface, the first predetermined thickness, first and second sides and first and second ends. A second notch is provided. The second notch is located upon the bottom surface and is spaced inwardly from the second end of the lamination support members. The second notch has first and second side walls and a second upper bearing surface. The second notch is sized and shaped to fit slidably over the first predetermined thickness of the second die board.

When the planar lower surfaces of the first and second die boards are located upon the horizontal surface and the first and second notches of the lamination support members are located upon the first and second curved upper surfaces of the first and second die boards, the top surfaces of the lamination support members will reflect the first and second curved upper surfaces of the first and second die boards and provide a curved surface for laminating veneer portions.

In still another variant, an insulating sheet is provided. The insulating sheet is formed of thin, flexible, resilient material. The insulating sheet is located between top surfaces of the lamination support members and a lower surface of a veneer portion being laminated upon the lamination support members. When the insulating sheet is inserted between the lamination support members and the lower surface of a veneer portion indentations in a lamination resulting from contact with top surfaces of the lamination support members will be minimized.

In still a further variant of the invention, the first upper bearing surface of the first notch includes a downward facing curve. The downward facing curve has its lowest point at a vertical centerline of the lamination support member. When the first notch of the lamination support members is located upon the first curved upper surface of the first die board, with the bottom surface adjacent the second end of the lamination support members located upon the horizontal surface, the top surfaces of the lamination support members will more accurately reflect the first curved upper surface of the first die board above a point where the downward facing curve of the first upper bearing surface of the first notch contacts the first curved upper surface and provide a curved surface for laminating veneer portions.

In another variant, the first and second upper bearing surfaces of the first and second notches include downward facing curves. The downward facing curves have their lowest points at a vertical centerline of the lamination support member. When the first and second notches of the lamination support members are located upon the first and second curved upper surfaces of the first and second die boards, the top surfaces of the lamination support members will more accurately reflect the first and second curved upper surfaces of the first and second die boards and provide a curved surface for laminating veneer portions.

In yet another variant, a series of closely spaced cuts extends orthogonally from the first side to the second side and from the top surface toward the bottom surface of the lamination support members. The cuts permit the top surfaces to assume a three-dimensional contoured configuration when a three-dimensional object having the configuration on an upper surface is placed between the horizontal surface and the bottom surface of the lamination support members. When the object causes the lamination support members to bend upwardly, a surface having compound curves will be formed for laminating veneer portions.

In still another variant, the first curved upper surface of the first die board includes an upward facing curve extending from the first side to the second side of the first die board.

In yet another variant of the invention, the top surface of each lamination support member includes an upward facing curve extending from the first side to the second side of the member.

In a further variant, the first upper bearing surface of the first notch is formed as a portion of an orifice located at a first predetermined distance from the top surface of the lamination support member. The first and second side walls of the first notch extend upwardly from the bottom surface of the support member and intersect a lower portion of a perimeter of the orifice.

In still a further variant, the first upper bearing surface of the first notch includes a downward facing curve extending from the first side to the second side of the lamination support member. The downward facing curve has its lowest point at a vertical centerline of the lamination support member.

A method for forming curved laminations includes the following steps. Providing a planar horizontal surface. Preparing a first die board. The first die board has a planar lower surface, a first curved upper surface, a first predetermined thickness, first and second sides and first and second ends. The first curved upper surface reflects a desired curve for at least one end of a lamination. Providing a plurality of lamination support members. The support members have parallel top and bottom surfaces, first and second sides, first and second ends, a second predetermined thickness. Positioning the lower planar surface of the first die board upon the horizontal surface.

Assembling the lamination support members upon the first die board and with the bottom surface adjacent the second end of the lamination support members located upon the horizontal surface. Providing an insulating sheet. The insulating sheet is formed of thin, flexible, resilient material and is designed to prevent indentations in a lamination resulting from contact with top surfaces of the lamination support members. Placing the insulating sheet upon the top surfaces of the lamination support members. Preparing at least two veneer portions. The veneer portions are sized and shaped to fit above the top surfaces of the lamination support members. Providing a glue layer between the veneer portions. Placing the veneer portions upon the insulating sheet. Applying pressure to an upper surface of a top veneer portion. Allowing the glue to dry and removing the laminated veneer portions from the insulating sheet.

A variant of the method for forming curved laminations includes the following steps. Providing a planar horizontal surface and preparing a first die board. The first die board has a planar lower surface, a first curved upper surface, a first predetermined thickness, first and second sides and first and second ends. The first curved upper surface reflects a desired curve for at least one end of a lamination. Preparing a second die board. The second die board has a planar lower surface, a second curved upper surface, a third predetermined thickness, first and second sides and first and second ends. The second curved upper surface reflects a desired curve for at least one end of a lamination.

Providing a plurality of lamination support members. The support members have parallel top and bottom surfaces, first and second sides, first and second ends and a second predetermined thickness. Positioning the lower planar surfaces of the first and second die boards upon the horizontal surface with the first die board parallel to the second die board. The first die board is spaced from the second die board. Assembling the lamination support members upon the first and second die boards. Providing an insulating sheet. The insulating sheet is formed of thin, flexible, resilient material and is designed to prevent indentations in a lamination resulting from contact with top surfaces of the lamination support members. Placing the insulating sheet upon the top surfaces of the lamination support members.

Preparing at least two veneer portions. The veneer portions are sized and shaped to fit above the top surfaces of the lamination support members. Providing a glue layer between the veneer portions. Placing the veneer portions upon the insulating sheet. Applying pressure to an upper surface of a top veneer portion. Allowing the glue to dry and removing the laminated veneer portions from the insulating sheet.

A further variant of the method includes the following steps. Providing a planar horizontal surface. Preparing a first die board. The first die board has a planar lower surface, a first curved upper surface, a first predetermined thickness, first and second sides and first and second ends. The first curved upper surface reflecting a desired curve for at least one end of a lamination. Providing a plurality of lamination support members. The support members have parallel top and bottom surfaces, first and second sides, first and second ends and a fourth predetermined thickness.

A first notch is located upon the bottom surface of the support member and spaced inwardly from the first end. The first notch has first and second side walls and a first upper bearing surface. The first notch is sized and shaped to fit slidably over the first predetermined thickness of the first die board. Positioning the lower planar surface of the first die board upon the horizontal surface. Assembling the lamination support members upon the first die board with the first notches engaging the first curved upper surface of the first die board and with the bottom surface adjacent the second end of the lamination support members located upon the horizontal surface. Providing an insulating sheet. The insulating sheet is formed of thin, flexible, resilient material and is designed to prevent indentations in a lamination resulting from contact with top surfaces of the lamination support members. Placing the insulating sheet upon the top surfaces of the lamination support members. Preparing at least two veneer portions, the veneer portions are sized and shaped to fit above the top surfaces of the lamination support members. Providing a glue layer between the veneer portions. Placing the veneer portions upon the insulating sheet. Applying pressure to an upper surface of a top veneer portion. Allowing the glue to dry and removing the laminated veneer portions from the insulating sheet.

Yet a further variant of the method includes the following steps. Providing a planar horizontal surface. Preparing a first die board. The first die board has a planar lower surface, a first curved upper surface, a first predetermined thickness, first and second sides and first and second ends. The first curved upper surface reflects a desired curve for at least one end of a lamination. Preparing a second die board. The second die board has a planar lower surface, a second curved upper surface, the first predetermined thickness, first and second sides and first and second ends. The second curved upper surface reflects a desired curve for at least one end of a lamination.

Providing a plurality of lamination support members. The support members have parallel top and bottom surfaces, first and second sides, first and second ends, a fourth predetermined thickness and first and second notches located upon the bottom surface and spaced inwardly from the first end and second end, respectively. The first and second notches have first and second side walls and first and second upper bearing surfaces. The first and second notches are sized and shaped to fit slidably over the first predetermined thickness of the first and second die boards. Positioning the lower planar surfaces of the first and second die boards upon the horizontal surface with the first die board parallel to the second die board. The first die board is spaced from the second die board by a distance separating the first notch from the second notch. Assembling the lamination support members upon the first and second die boards with the first and second notches engaging the first and second curved upper surfaces of the first and second die boards.

Providing an insulating sheet. The insulating sheet is formed of thin, flexible, resilient material and is designed to prevent indentations in a lamination resulting from contact with top surfaces of the lamination support members. Placing the insulating sheet upon the top surfaces of the lamination support members. Preparing at least two veneer portions. The veneer portions are sized and shaped to fit above the top surfaces of the lamination support members. Providing a glue layer between the veneer portions. Placing the veneer portions upon the insulating sheet. Applying pressure to an upper surface of a top veneer portion. Allowing the glue to dry and removing the laminated veneer portions from the insulating sheet.

A further variant of the method for forming curved laminations includes the following steps. Applying pressure to the upper surface of the top veneer portion by inserting the apparatus for forming curved laminations together with the veneer portions with interleaved glue layer located upon the insulating sheet, located upon the top surfaces of the lamination support members, into a heavy duty, airtight plastic bag. Sealing the bag and evacuating the air from the bag, thereby allowing atmospheric pressure to conform the veneer portions to the insulating sheet and the top surface of the lamination support members.

Another variant of the apparatus for forming curved laminations includes a desired lamination profile. The profile includes a planar baseline, and an upper curve. The baseline has a first end, a second end, and is comprised of a series of equal-sized increments. The upper curve, defines a height above the baseline for each increment of the baseline from the first end to the second end. A plurality of adjacent lamination support members is provided. The support members have parallel top and bottom surfaces, first and second sides, first and second ends and a fifth predetermined thickness equal to the equal-sized increment. Each of the adjacent lamination support members have a height equal to the height of the upper curve of the desired lamination profile above the baseline for one of the equal-sized increments. Means are provided for maintaining the adjacent lamination support members in parallel alignment to one another, thereby yielding a curved surface defined by the adjacent top surfaces of the adjacent lamination support members. The curved surface is suitable for laminating veneer portions.

A final variant of the method for forming curved laminations includes the following steps. Developing a desired lamination profile. The profile includes a planar baseline, and an upper curve. The baseline has a first end, a second end, and is comprised of a series of equal-sized increments. The upper curve defines a height above the baseline for each increment of the baseline from the first end to the second end. Providing a plurality of adjacent lamination support members. The support members have parallel top and bottom surfaces, first and second sides, first and second ends and a fifth predetermined thickness equal to the equal-sized increment. Each of the adjacent lamination support members has a height equal to the height of the upper curve of the desired lamination profile above the baseline for one of the equal-sized increments. Maintaining the adjacent lamination support members in parallel alignment to one another, thereby yielding a curved surface defined by the adjacent top surfaces of the adjacent lamination support members. The curved surface is suitable for laminating veneer portions.

Providing an insulating sheet. The insulating sheet is formed of thin, flexible, resilient material and is designed to prevent indentations in a lamination resulting from contact with top surfaces of the adjacent lamination support members. Placing the insulating sheet upon the top surfaces of the adjacent lamination support members. Preparing at least two veneer portions. The veneer portions are sized and shaped to fit above the top surfaces of the adjacent lamination support members. Providing a glue layer between the veneer portions. Placing the veneer portions upon the insulating sheet. Applying pressure to an upper surface of a top veneer portion. Allowing the glue to dry and removing the laminated veneer portions from the insulating sheet.

Still another variant of the invention for forming curved laminations providing the desired features may be constructed from the following components. A planar horizontal surface is provided, as is a first die board. The first die board has a planar lower surface, a first curved upper surface, a first predetermined thickness, first and second sides and first and second ends. A plurality of lamination support members is provided. The support members have top and bottom surfaces, first and second sides, first and second ends and a second predetermined thickness.

When the planar lower surface of the first die board is located upon the horizontal surface and the lamination support members are located upon the first curved upper surface of the first die board with the bottom surface adjacent the second end of the lamination support members located upon the horizontal surface, the top surfaces of the lamination support members will reflect the first curved upper surface of the first die board above a point where the lamination support members contact the first upper surface and provide a curved surface for laminating veneer portions.

In a further variant of the invention, a second die board is provided. The second die board has a planar lower surface, a second curved upper surface, a third predetermined thickness, first and second sides and first and second ends. When the planar lower surfaces of the first and second die boards are located upon the horizontal surface and the lamination support members are located upon the first and second curved upper surfaces of the first and second die boards, the top surfaces of the lamination support members will reflect the first and second curved upper surfaces of the first and second die boards and provide a curved surface for laminating veneer portions.

In still another variant, a planar horizontal surface is provided, as is a first die board. The first die board has a planar lower surface, a first curved upper surface, a first predetermined thickness, first and second sides and first and second ends. A plurality of lamination support members is provided. The support members have top and bottom surfaces, first and second sides, first and second ends, a fourth predetermined thickness and a first notch located upon the bottom surface and spaced inwardly from the first end. The first notch has first and second side walls and a first upper bearing surface. The first notch is sized and shaped to fit slidably over the first predetermined thickness of the first die board.

When the planar lower surface of the first die board is located upon the horizontal surface and the first notches of the lamination support members are located upon the first curved upper surface of the first die board with the bottom surface adjacent the second end of the lamination support members located upon the horizontal surface, the top surfaces of the lamination support members will reflect the first curved upper surface of the first die board above a point where the first notches contact the first upper surface and provide a curved surface for laminating veneer portions.

In a final variant, a second die board is provided. The second die board has a planar lower surface, a second curved upper surface, the first predetermined thickness, first and second sides and first and second ends. A second notch is provided. The second notch is located upon the bottom surface and is spaced inwardly from the second end of the lamination support members. The second notch has first and second side walls and a second upper bearing surface. The second notch is sized and shaped to fit slidably over the first predetermined thickness of the second die board.

When the planar lower surfaces of the first and second die boards are located upon the horizontal surface and the first and second notches of the lamination support members are located upon the first and second curved upper surfaces of the first and second die boards, the top surfaces of the lamination support members will reflect the first and second curved upper surfaces of the first and second die boards and provide a curved surface for laminating veneer portions.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a first embodiment of the invention including a single die board;

FIG. 2 is a perspective view of the FIG. 1 embodiment including a second die board;

FIG. 3 is a perspective view of the FIG. 1 embodiment including cylindrical lamination support members;

FIG. 4 is a side view of the FIG. 1 embodiment including lamination support members having a projecting tongue and a mating rounded, receiving notch;

FIG. 5 is a side view of the FIG. 1 embodiment including an insulating sheet located above the lamination support members;

FIG. 6 is a perspective view of a second embodiment of the invention including a single die board and notched lamination support members being assembled;

FIG. 6A is a perspective view of the FIG. 6 embodiment as assembled;

FIG. 7 is a perspective view of the second embodiment of the invention including a second die board and dual notched lamination support members being assembled;

FIG. 7A is a perspective view of the FIG. 7 embodiment as assembled;

FIG. 8 is a side view of the FIG. 7 embodiment including an insulating sheet located above the notched lamination support members;

FIG. 9 is a perspective view of a notched lamination support member for use with the FIG. 6 embodiment including a downward facing curve on the first upper bearing surface of the first notch;

FIG. 9A is a cross-sectional end view detail of the FIG. 9 support member taken along the line 9A-9A;

FIG. 10 is a perspective view of a notched lamination support member for use with the FIG. 7 embodiment including downward facing curves on the first and second upper bearing surfaces of the first and second notches;

FIG. 11 is a perspective view of the FIG. 7 embodiment including means for producing laminations in a second plane;

FIG. 11A is a perspective view of a lamination support member having a series of vertical slits extending from the top surface toward the bottom surface for use with the FIG. 11 embodiment;

FIG. 12 is a perspective view of a die board having a curved upper surface;

FIG. 13 is a perspective view of a lamination support member having a curved top surface;

FIG. 14 is a perspective view of a lamination support member having the upper bearing surfaces of the first and second notches formed as a portion of an orifice located at a first predetermined distance from the top surface of the member;

FIG. 15 is a perspective view of the FIG. 14 lamination support member including downward facing curves at the upper bearing surfaces;

FIG. 15A is a cross-sectional end view detail of the FIG. 15 support member taken along the line 15A-15A;

FIG. 16 is a perspective view of the method of forming a curved lamination using the FIG. 3 embodiment and insulating sheet;

FIG. 17 is a perspective view of the method of forming a curved lamination using the FIG. 2 embodiment and insulating sheet;

FIG. 18 is a perspective view of the method of forming a curved lamination using the FIG. 6 embodiment and insulating sheet;

FIG. 19 is a perspective view of the method of forming a curved lamination using the FIG. 7 embodiment and insulating sheet;

FIG. 20 is a side view of the method of forming a curved lamination using the FIG. 7 embodiment and a sealable, flexible bag and vacuum pump to compress the laminations upon the lamination support members and insulating sheet;

FIG. 21A is a plan view of a desired lamination profile;

FIG. 21B is an end view of a series of lamination support members formed according to the desired lamination profile;

FIG. 21C is an end view of the method of forming a curved lamination using the FIG. 21B embodiment and insulating sheet;

FIG. 22 is a perspective view of a first embodiment of the invention including a single die board and lamination support members having top and bottom surfaces that are not parallel;

FIG. 23 is a perspective view of the FIG. 1 embodiment including a second die board and cylindrical lamination support members in the form of truncated cones;

FIG. 24 is a perspective view of a second embodiment of the invention including a single die board and notched lamination support members having top and bottom surfaces that are not parallel; and

FIG. 25 is a perspective view of the second embodiment of the invention including a second die board and dual notched lamination support members having top and bottom surfaces that are not parallel.

### DETAILED DESCRIPTION OF THE PREFERRED EMBODIMENT

FIGS. 1-5 illustrate an apparatus 10 for forming curved laminations providing the desired features that may be constructed from the following components. As illustrated in FIG. 1, a planar horizontal surface 14 is provided as is a first die board 18. The first die board 18 has a planar lower surface 22, a first curved upper surface 26, a first predetermined thickness 30, first 34 and second 38 sides and first 42 and second 46 ends. A plurality of lamination support members 50 is provided. The support members 50 have parallel top 54 and bottom 58 surfaces, first 62 and second 66 sides, first 70 and second 74 ends and a second predetermined thickness 78.

When the planar lower surface 22 of the first die board 18 is located upon the horizontal surface 14 and the lamination support members 50 are located upon the first curved upper surface 26 of the first die board 18 with the bottom surface 58 adjacent the second end 46 of the lamination support members 50 located upon the horizontal surface 14, the top surfaces 54 of the lamination support members 50 will reflect the first curved upper surface 26 of the first die board 18 above a point where the lamination support members 50 contact the first upper surface 26 and provide a curved surface 82 for laminating veneer portions(not shown).

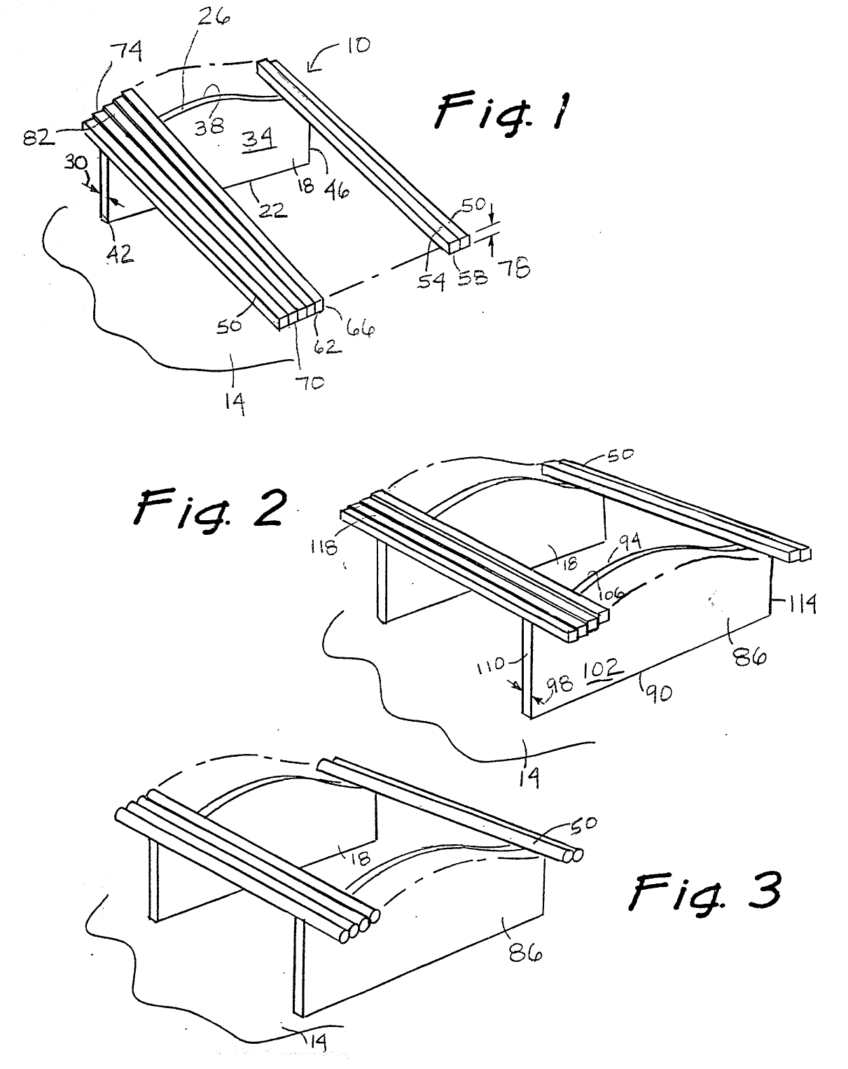

In a variant of the invention, as illustrated in FIG. 2, a second die board 86 is provided. The second die board 86 has a planar lower surface 90, a second curved upper surface 94, a second predetermined thickness 98, first 102 and second 106 sides and first 110 and second 114 ends. When the planar lower surfaces 22, 90 of the first 18 and second 86 die boards are located upon the horizontal surface 14 and the lamination support members 50 are located upon the first 26 and second 94 curved upper surfaces of the first 18 and second 86 die boards, the top surfaces 54 of the lamination support members 50 will reflect the first 26 and second 94 curved upper surfaces of the first 18 and second 86 die boards and provide a curved surface 118 for laminating veneer portions (not shown).

In a further variant, as illustrated in FIG. 3, the lamination support members 50 are cylindrical in cross-section. In still a further variant, as illustrated in FIG. 4, the lamination support members 50 are substantially rectangular in cross-section. The first side 62 of the lamination support member 50 includes a rounded projecting tongue 122 and the second side 66 of the lamination support member 50 includes a mating rounded, receiving notch 126. Adjacent lamination support members 50 will fit more closely together while following the first curved upper surface 26 of the first die board 18, thereby forming a smoother surface upon which veneer portions are laminated.

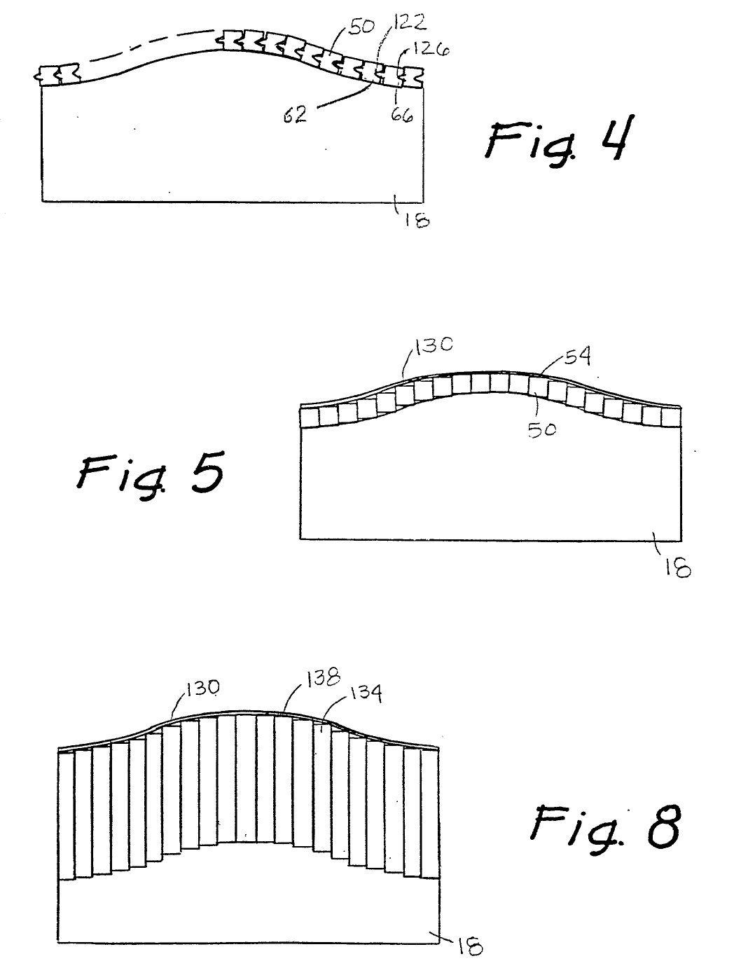

In another variant of the invention, as illustrated in FIG. 5, an insulating sheet 130 is provided. The insulating sheet 130 is formed of thin, flexible, resilient material. The insulating sheet 130 is located between top surfaces 54 of the lamination support members 50 and a lower surface (not shown) of a veneer portion (not shown) being laminated upon the lamination support members 50. When the insulating sheet 130 is inserted between the lamination support members 50 and the lower surface of a veneer portion indentations in a lamination resulting from contact with top surfaces 54 of the lamination support members 50 will be minimized.

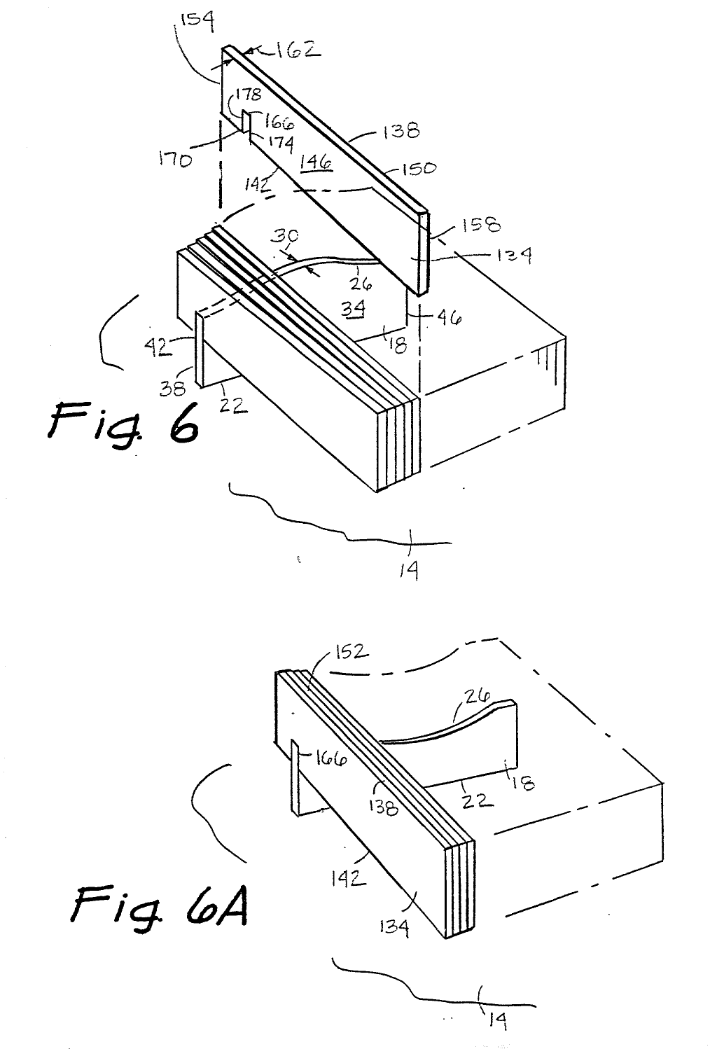

In still another variant, as illustrated in FIGS. 6 and 6A, a planar horizontal surface 14 is provided as is a first die board 18. The first die board 18 has a planar lower surface 22, a first curved upper surface 26, a first predetermined thickness 30, first 34 and second 38 sides and first 42 and second 46 ends. A plurality of lamination support members 134 is provided. The support members 134 have parallel top 138 and bottom 142 surfaces, first 146 and second 150 sides, first 154 and second 158 ends, a fourth predetermined thickness 162 and a first notch 166 located upon the bottom surface 142 and spaced inwardly from the first end 154. The first notch 166 has first 170 and second 174 side walls and a first upper bearing surface 178. The first notch 166 is sized and shaped to fit slidably over the first predetermined thickness 30 of the first die board 18.

When the planar lower surface 22 of the first die board 18 is located upon the horizontal surface 14 and the first notches 166 of the lamination support members 134 are located upon the first curved upper surface 26 of the first die board 18 with the bottom surface 142 adjacent the second end 158 of the lamination support members 134 located upon the horizontal surface 14, the top surfaces 138 of the lamination support members 134 will reflect the first curved upper surface 26 of the first die board 18 above a point where the first notches 166 contact the first upper surface 26 and provide a curved surface 182 for laminating veneer portions.

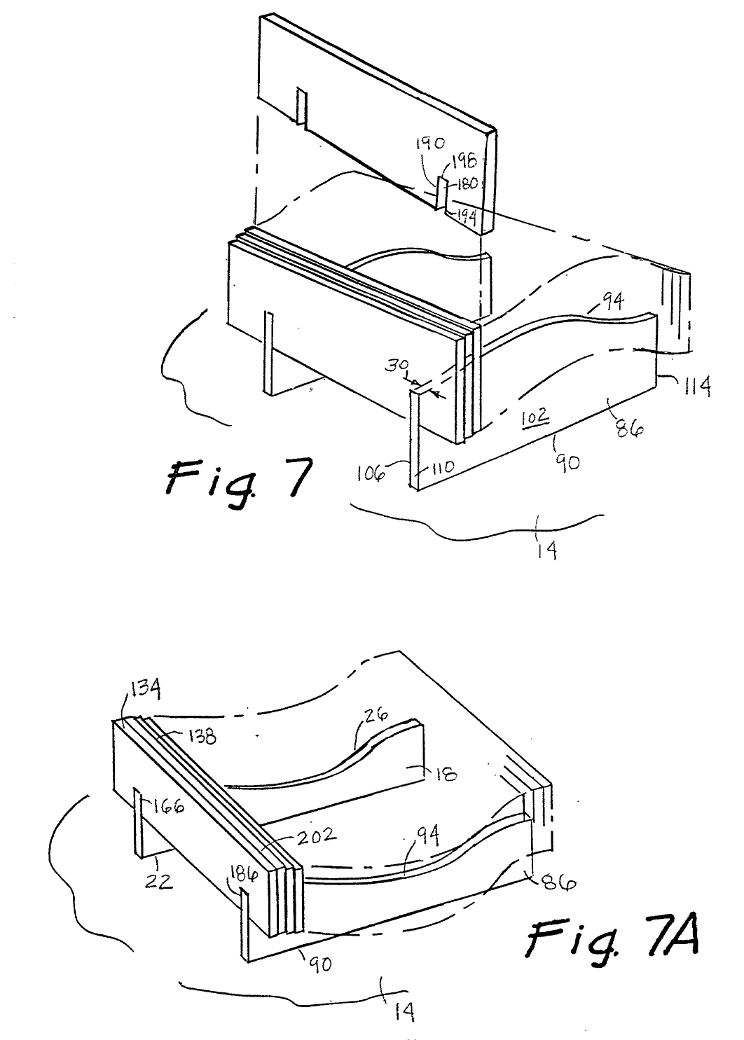

In yet another variant, as illustrated in FIGS. 7 and 7A, a second die board 86 is provided. The second die board 86 has a planar lower surface 90, a second curved upper surface 94, the first predetermined thickness 30, first 102 and second 106 sides and first 110 and second 114 ends. A second notch 186 is provided. The second notch 186 is located upon the bottom surface 142 and is spaced inwardly from the second end 150 of the lamination support members 134. The second notch 186 has first 190 and second 194 side walls and a second upper bearing surface 198. The second notch 186 is sized and shaped to fit slidably over the first predetermined thickness 30 of the second die board 86.

When the planar lower surfaces 22, 90 of the first 18 and second 86 die boards are located upon the horizontal surface 14 and the first 166 and second 186 notches of the lamination support members 134 are located upon the first 26 and second 94 curved upper surfaces of the first 18 and second 86 die boards, the top surfaces 138 of the lamination support members 134 will reflect the first 26 and second 94 curved upper surfaces of the first 18 and second 86 die boards and provide a curved surface 202 for laminating veneer portions.

In still another variant, as illustrated in FIG. 8, an insulating sheet 130 is provided.

The insulating sheet 130 is formed of thin, flexible, resilient material. The insulating sheet 130 is located between top surfaces 138 of the lamination support members 134 and a lower surface (not shown) of a veneer portion being laminated upon the lamination support members 134. When the insulating sheet 130 is inserted between the lamination support members 134 and the lower surface of a veneer portion, indentations in a lamination resulting from contact with top surfaces 138 of the lamination support members 134 will be minimized.

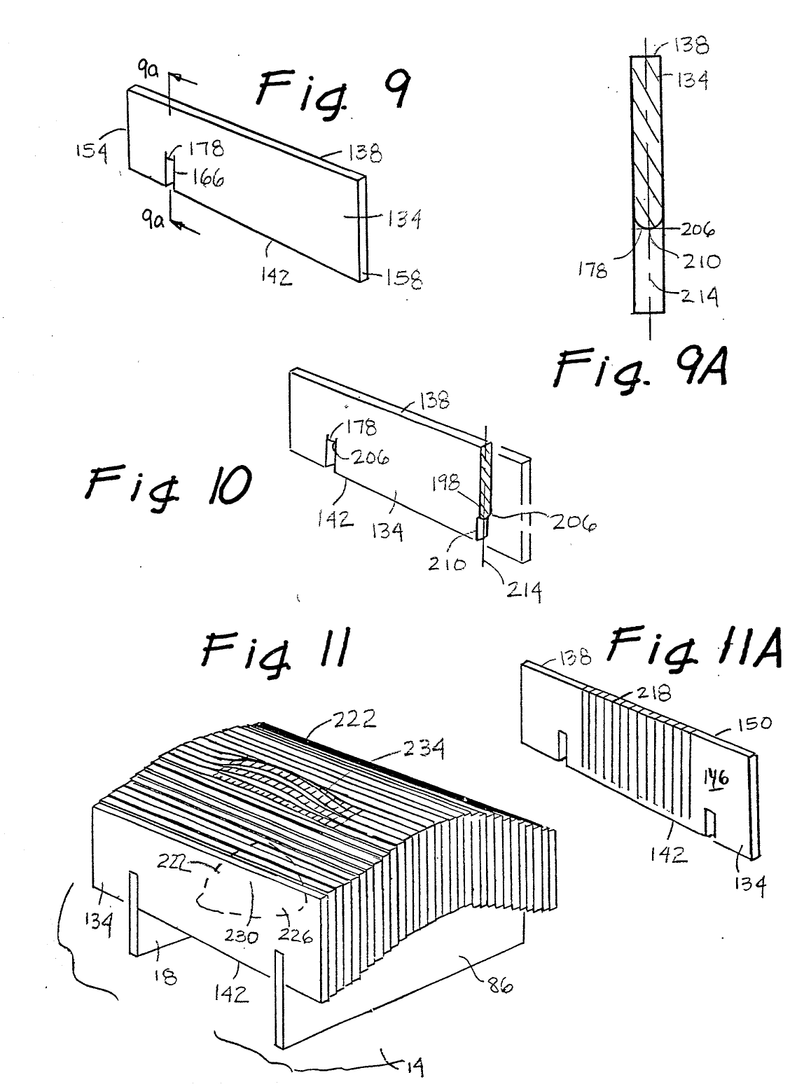

In still a further variant of the invention, as illustrated in FIGS. 9 and 9A, the first upper bearing surface 178 of the first notch 166 includes a downward facing curve 206. The downward facing curve 206 has its lowest point 210 at a vertical centerline 214 of the lamination support member 134. When the first notch 166 of the lamination support members 134 is located upon the first curved upper surface 26 of the first die board 18, with the bottom surface 58 adjacent the second end 46 of the lamination support members 134 located upon the horizontal surface 14, the top surfaces 138 of the lamination support members 134 will more accurately reflect the first curved upper surface 26 of the first die board 18 above a point where the downward facing curve 206 of the first upper bearing surface 178 of the first notch 166 contacts the first curved upper surface 26 and provide a curved surface (not shown) for laminating veneer portions.

In another variant, as illustrated in FIG. 10, the first 178 and second 198 upper bearing surfaces of the first 166 and second 186 notches include downward facing curves 206. The downward facing curves 206 have their lowest points 210 at a vertical centerline 214 of the lamination support member 134. When the first 166 and second 186 notches of the lamination support members 134 are located upon the first 26 and second 94 curved upper surfaces of the first 18 and second 86 die boards, the top surfaces 138 of the lamination support members 134 will more accurately reflect the first 26 and second 94 curved upper surfaces of the first 18 and second 86 die boards and provide a curved surface (not shown) for laminating veneer portions.

In yet another variant, as illustrated in FIGS. 11 and 11A, a series of closely spaced cuts 218 extends orthogonally from the first side 146 to the second side 150 and from the top surface 138 toward the bottom surface 142 of the lamination support members 134. The cuts 218 permit the top surfaces 138 to assume a three-dimensional contoured configuration 222 when a three-dimensional object 226 having the configuration 222 on an upper surface 230 is placed between the horizontal surface 14 and the bottom surface 142 of the lamination support members 134. When the object 226 causes the lamination support members 134 to bend upwardly, a surface having compound curves 234 will be formed for laminating veneer portions.

In still another variant, as illustrated in FIG. 12, the first curved upper surface 26 of the first die board 18 includes an upward facing curve 238 extending from the first side 34 to the second side 38 of the first die board 18.

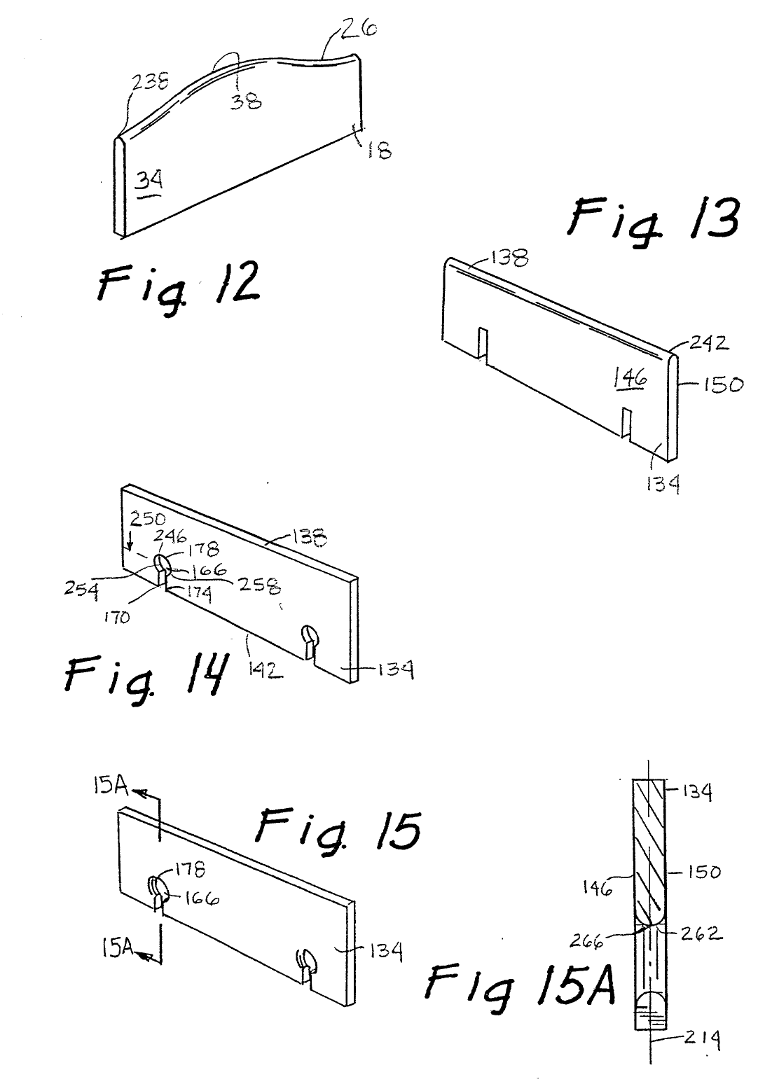

In yet another variant of the invention, as illustrated in FIG. 13, the top surface 138 of each lamination support member 134 includes an upward facing curve 242 extending from the first side 146 to the second side 150 of the member 134.

In a further variant, as illustrated in FIG. 14, the first upper bearing surface 178 of the first notch 166 is formed as a portion of an orifice 246 located at a first predetermined distance 250 from the top surface 138 of the lamination support member 134. The first 170 and second 174 side walls of the first notch 166 extend upwardly from the bottom surface 142 of the support member 134 and intersect a lower portion 254 of a perimeter 258 of the orifice 246.

In still a further variant, as illustrated in FIGS. 15 and 15A, the first upper bearing surface 178 of the first notch 166 includes a downward facing curve 262 extending from the first side 146 to the second side 150 of the lamination support member 134. The downward facing curve 262 has its lowest point 266 at a vertical centerline 214 of the lamination support member 134.

A method for forming curved laminations 270, as illustrated in FIG. 16, includes the following steps. Providing a planar horizontal surface 14. Preparing a first die board 18. The first die board 18 has a planar lower surface 22, a first curved upper surface 26, a first predetermined thickness 30, first 34 and second 38 sides and first 42 and second 46 ends. The first curved upper surface 26 reflects a desired curve for at least one end of a lamination. Providing a plurality of lamination support members 50. The support members 50 have parallel top 54 and bottom 58 surfaces, first 62 and second 66 sides, first 70 and second 74 ends, a second predetermined thickness 78. Positioning the lower planar surface 22 of the first die board 18 upon the horizontal surface 14.

Assembling the lamination support members 50 upon the first die board 18 and with the bottom surface 58 adjacent the second end 74 of the lamination support members 50 located upon the horizontal surface 14. Providing an insulating sheet 130. The insulating sheet 130 is formed of thin, flexible, resilient material and is designed to prevent indentations in a lamination resulting from contact with top surfaces 54 of the lamination support members 50. Placing the insulating sheet 130 upon the top surfaces 54 of the lamination support members 50. Preparing at least two veneer portions 274. The veneer portions 274 are sized and shaped to fit above the top surfaces 54 of the lamination support members 50. Providing a glue layer 278 between the veneer portions 274. Placing the veneer portions 274 upon the insulating sheet 130. Applying pressure 282 to an upper surface 286 of a top veneer portion 290. Allowing the glue 278 to dry and removing the laminated veneer portions 274 from the insulating sheet 130.

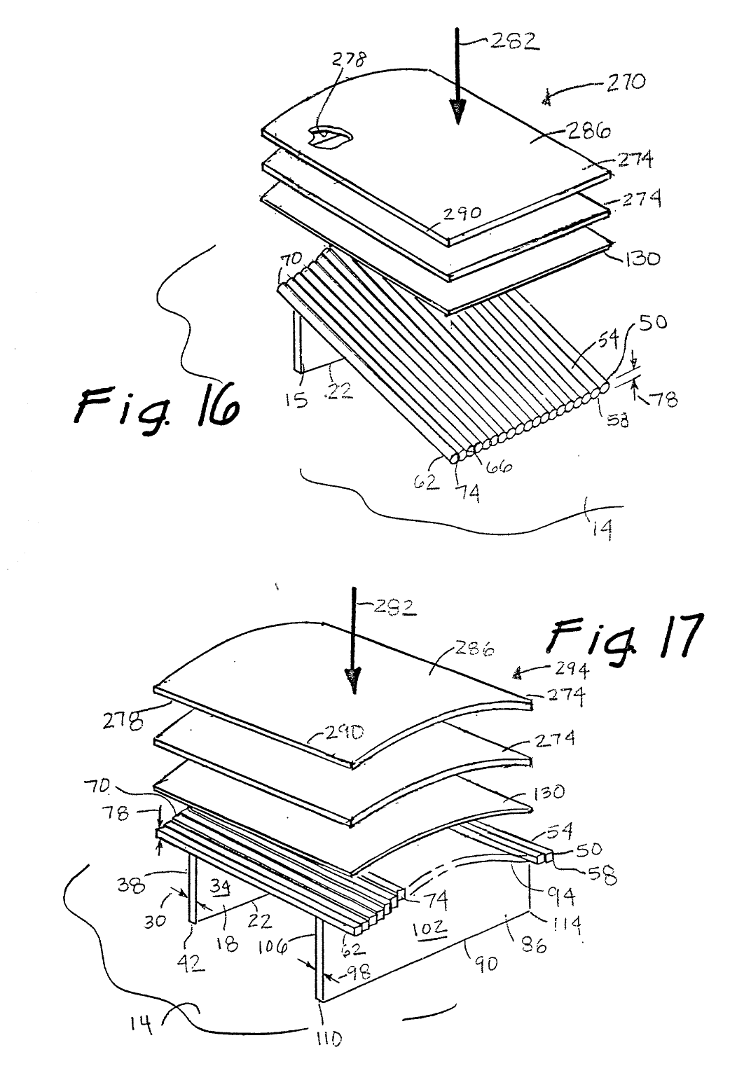

A variant of the method for forming curved laminations 294, as illustrated in FIG. 17, includes the following steps. Providing a planar horizontal surface 14 and preparing a first die board 18. The first die board 18 has a planar lower surface 22, a first curved upper surface 26, a first predetermined thickness 30, first 34 and second 38 sides and first 42 and second 46 ends. The first curved upper surface 26 reflects a desired curve for at least one end of a lamination. Preparing a second die board 86. The second die board 86 has a planar lower surface 90, a second curved upper surface 94, a third predetermined thickness 98, first 102 and second 106 sides and first 110 and second 114 ends. The second curved upper surface 94 reflects a desired curve for at least one end of a lamination.

Providing a plurality of lamination support members 50. The support members 50 have parallel top 54 and bottom 58 surfaces, first 62 and second 66 sides, first 70 and second 74 ends and a second predetermined thickness 78. Positioning the lower planar surfaces 22, 90 of the first 18 and second 86 die boards upon the horizontal surface 14 with the first die board 18 parallel to the second die board 86. The first die board 18 is spaced from the second die board 86. Assembling the lamination support members 50 upon the first 18 and second 86 die boards. Providing an insulating sheet 130. The insulating sheet 130 is formed of thin, flexible, resilient material and is designed to prevent indentations in a lamination resulting from contact with top surfaces 54 of the lamination support members 50. Placing the insulating sheet 130 upon the top surfaces 54 of the lamination support members 50.

Preparing at least two veneer portions 274. The veneer portions 274 are sized and shaped to fit above the top surfaces 54 of the lamination support members 50. Providing a glue layer 278 between the veneer portions 274. Placing the veneer portions 274 upon the insulating sheet 130. Applying pressure 282 to an upper surface 286 of a top veneer portion 290. Allowing the glue 278 to dry and removing the laminated veneer portions 274 from the insulating sheet 130.

A further variant of the method 298, as illustrated in FIG. 18, includes the following steps. Providing a planar horizontal surface 14. Preparing a first die board 18. The first die board 18 has a planar lower surface 22, a first curved upper surface 26, a first predetermined thickness 30, first 34 and second 38 sides and first 42 and second 46 ends. The first curved upper surface 26 reflecting a desired curve for at least one end of a lamination. Providing a plurality of lamination support members 134. The support members 134 have parallel top 138 and bottom 142 surfaces, first 146 and second 150 sides, first 154 and second 158 ends and a fourth predetermined thickness 162.

A first notch 166 is located upon the bottom surface 142 of the support member 134 and spaced inwardly from the first end 154. The first notch 166 has first 170 and second 174 side walls and a first upper bearing surface 178. The first notch 166 is sized and shaped to fit slidably over the first predetermined thickness 30 of the first die board 18. Positioning the lower planar surface 22 of the first die board 18 upon the horizontal surface 14. Assembling the lamination support members 134 upon the first die board 18 with the first notches 166 engaging the first curved upper surface 26 of the first die board 18 and with the bottom surface 142 adjacent the second end 158 of the lamination support members 134 located upon the horizontal surface 14. Providing an insulating sheet 130. The insulating sheet 130 is formed of thin, flexible, resilient material and is designed to prevent indentations in a lamination resulting from contact with top surfaces 138 of the lamination support members 134. Placing the insulating sheet 130 upon the top surfaces 138 of the lamination support members 134. Preparing at least two veneer portions 274, the veneer portions 274 are sized and shaped to fit above the top surfaces 138 of the lamination support members 134. Providing a glue layer 278 between the veneer portions 274. Placing the veneer portions 274 upon the insulating sheet 130. Applying pressure 282 to an upper surface 286 of a top veneer portion 290. Allowing the glue 278 to dry and removing the laminated veneer portions 274 from the insulating sheet 130.

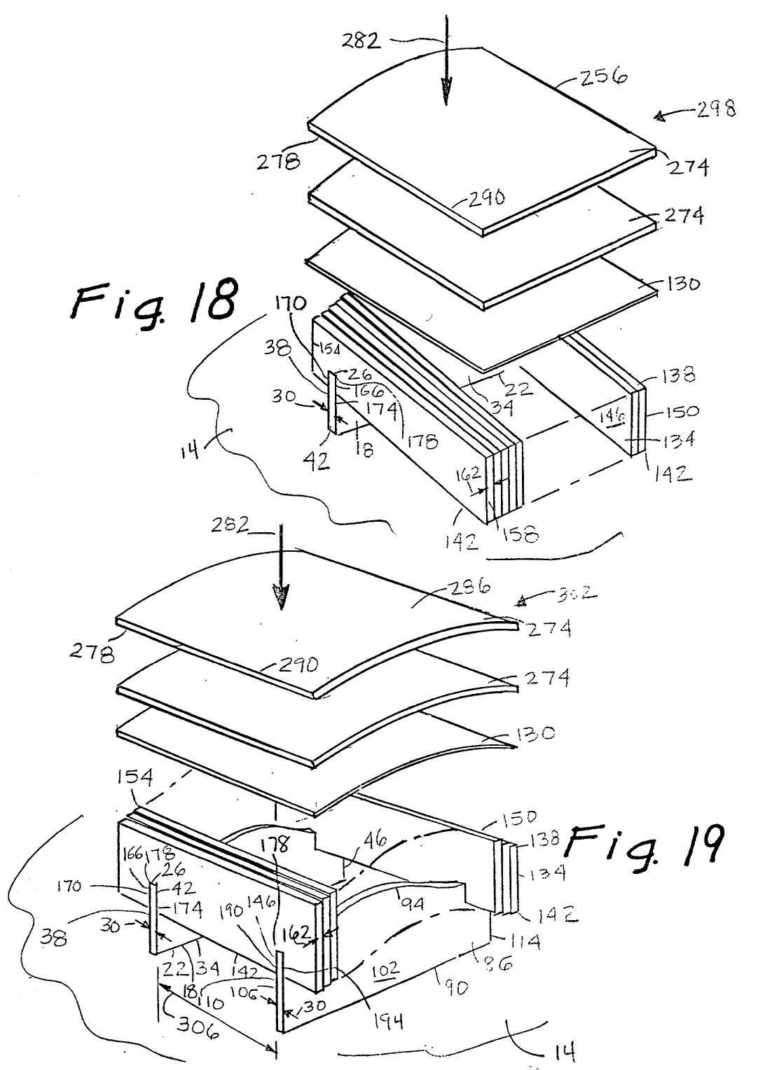

Yet a further variant of the method 302, as illustrated in FIG. 19, includes the following steps. Providing a planar horizontal surface 14. Preparing a first die board 18. The first die board 18 has a planar lower surface 22, a first curved upper surface 26, a first predetermined thickness 30, first 34 and second 38 sides and first 42 and second ends 46. The first curved upper surface 26 reflects a desired curve for at least one end of a lamination. Preparing a second die board 86. The second die board 86 has a planar lower surface 90, a second curved upper surface 94, the first predetermined thickness 30, first 102 and second 106 sides and first 110 and second 114 ends. The second curved upper surface 94 reflects a desired curve for at least one end of a lamination.

Providing a plurality of lamination support members 134. The support members 134 have parallel top 138 and bottom 142 surfaces, first 146 and second 150 sides, first 154 and second 158 ends, a fourth predetermined thickness 162 and first 166 and second 186 notches located upon the bottom surface 142 and spaced inwardly from the first end 154 and second 158 end, respectively. The first 166 and second 186 notches have first 170, 190 and second 174, 194 side walls and first 178 and second 198 upper bearing surfaces. The first 166 and second 186 notches are sized and shaped to fit slidably over the first predetermined thickness 30 of the first 18 and second 86 die boards. Positioning the lower planar surfaces 22, 90 of the first 18 and second 86 die boards upon the horizontal surface 14 with the first die board 18 parallel to the second die board 86. The first die board 18 is spaced from the second die board 86 by a distance 306 separating the first notch 166 from the second notch 186. Assembling the lamination support members 134 upon the first 18 and second 86 die boards with the first 166 and second 186 notches engaging the first 26 and second 94 curved upper surfaces of the first 18 and second 86 die boards.

Providing an insulating sheet 130. The insulating sheet 130 is formed of thin, flexible, resilient material and is designed to prevent indentations in a lamination resulting from contact with top surfaces 138 of the lamination support members 134. Placing the insulating sheet 130 upon the top surfaces 138 of the lamination support members 134. Preparing at least two veneer portions 274. The veneer portions 274 are sized and shaped to fit above the top surfaces 138 of the lamination support members 134. Providing a glue layer 278 between the veneer portions 274. Placing the veneer portions 274 upon the insulating sheet 130. Applying pressure 282 to an upper surface 286 of a top veneer portion 290. Allowing the glue 278 to dry and removing the laminated veneer portions 274 from the insulating sheet 130.

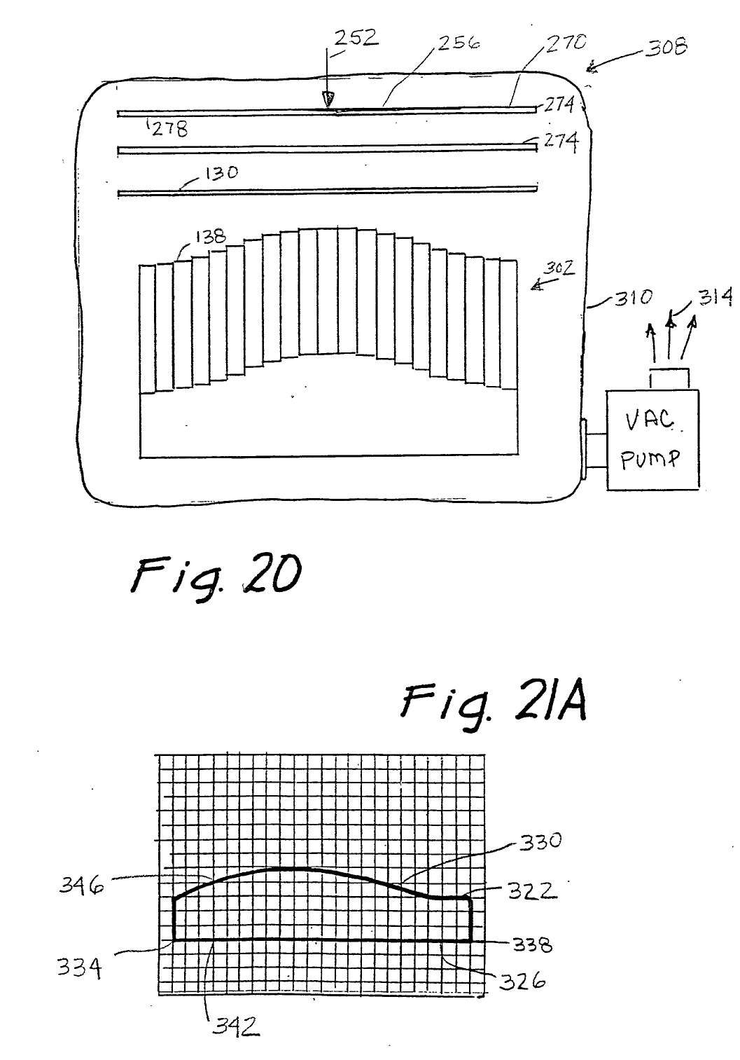

A further variant of the method for forming curved laminations 306, as illustrated in FIG. 20, includes the following steps. Applying pressure 282 to the upper surface 286 of the top veneer portion 290 by inserting the apparatus for forming curved laminations 302 together with the veneer portions 274 with interleaved glue layer 278 located upon the insulating sheet 130, located upon the top surfaces 138 of the lamination support members 134, into a heavy duty, airtight plastic bag 310. Sealing the bag 310 and evacuating the air 314 from the bag 310, thereby allowing atmospheric pressure 282 to conform the veneer portions 274 to the insulating sheet 130 and the top surface 138 of the lamination support members 134.

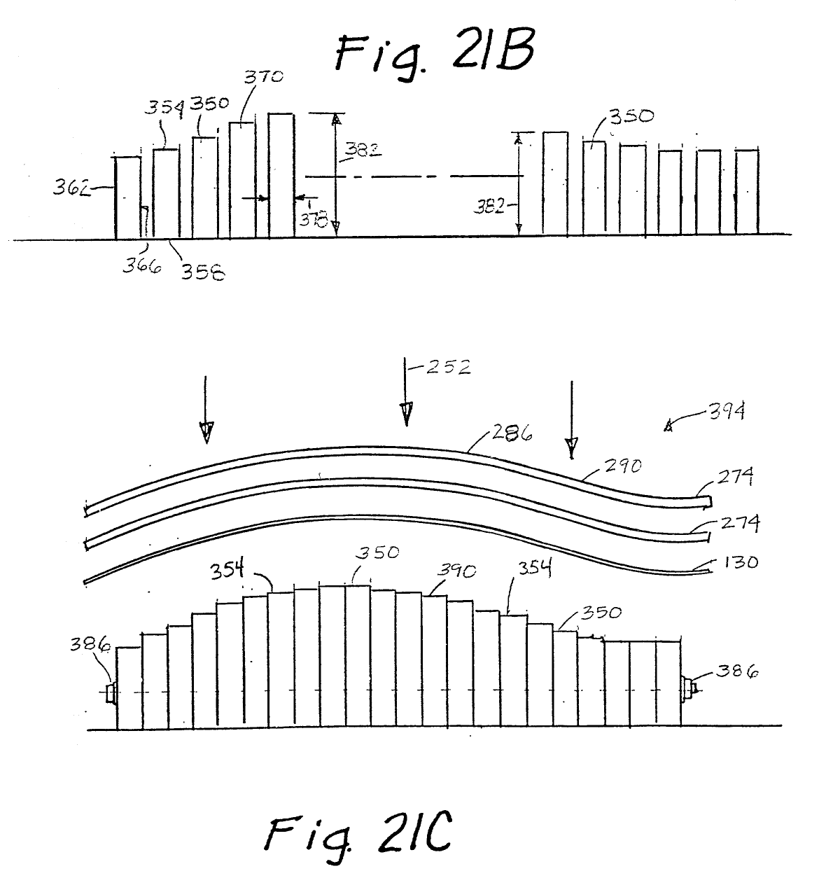

A final variant of the apparatus for forming curved laminations, as illustrated in FIGS. 21A, 21B and 21C, includes a desired lamination profile 322. The profile 322 includes a planar baseline 326, and an upper curve 330. The baseline 326 has a first end 334, a second end 338, and is comprised of a series of equal-sized increments 342. The upper curve 330, defines a height 346 above the baseline 326 for each increment 342 of the baseline 326 from the first end 334 to the second end 338. A plurality of adjacent lamination support members 350 is provided. The support members 350 have parallel top 354 and bottom 358 surfaces, first 362 and second 366 sides, first 370 and second 374 ends and a fifth predetermined thickness 378 equal to the equal-sized increment 342. Each of the adjacent lamination support members 350 has a height 382 equal to the height 346 of the upper curve 330 of the desired lamination profile 322 above the baseline 326 for one of the equal-sized increments 342. Means 386 are provided for maintaining the adjacent lamination support members 350 in parallel alignment to one another, thereby yielding a curved surface 390 defined by the adjacent top surfaces 354 of the adjacent lamination support members 350. The curved surface 390 is suitable for laminating veneer portions.

A final variant of the method for forming curved laminations 394, as illustrated in FIGS. 21A, 21B and 21C, includes the following steps. Developing a desired lamination profile 322. The profile 322 includes a planar baseline 326, and an upper curve 330. The baseline 326 has a first end 334, a second end 338, and is comprised of a series of equal-sized increments 342. The upper curve 330 defines a height 346 above the baseline 326 for each increment 342 of the baseline 326 from the first end 334 to the second end 338. Providing a plurality of adjacent lamination support members 350. The support members 350 have parallel top 354 and bottom 358 surfaces, first 362 and second 366 sides, first 370 and second 374 ends and a fifth predetermined thickness 378 equal to the equal-sized increment 342. Each of the adjacent lamination support members 350 has a height 382 equal to the height 346 of the upper curve 330 of the desired lamination profile 322 above the baseline 326 for one of the equal-sized increments 342. Maintaining the adjacent lamination support members 350 in parallel alignment to one another, thereby yielding a curved surface 390 defined by the adjacent top surfaces 354 of the adjacent lamination support members 350. The curved surface 390 is suitable for laminating veneer portions.

Providing an insulating sheet 130. The insulating sheet 130 is formed of thin, flexible, resilient material and is designed to prevent indentations in a lamination resulting from contact with top surfaces 354 of the adjacent lamination support members 350. Placing the insulating sheet 130 upon the top surfaces 354 of the lamination support members 350. Preparing at least two veneer portions 274. The veneer portions 274 are sized and shaped to fit above the top surfaces 354 of the lamination support members 350. Providing a glue layer 278 between the veneer portions 274. Placing the veneer portions 274 upon the insulating sheet 130. Applying pressure 282 to an upper surface 286 of a top veneer portion 290. Allowing the glue 278 to dry and removing the laminated veneer portions 274 from the insulating sheet 130.

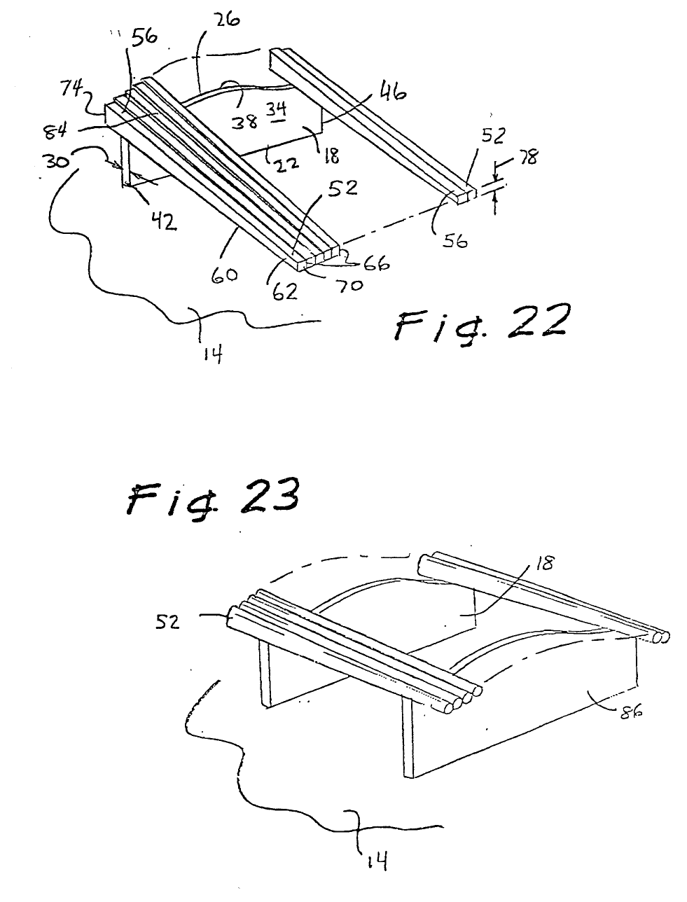

FIGS. 22-25 illustrate an apparatus 10 for forming curved laminations providing the desired features that may be constructed from the following components. As illustrated in FIG. 22, a planar horizontal surface 14 is provided as is a first die board 18. The first die board 18 has a planar lower surface 22, a first curved upper surface 26, a first predetermined thickness 30, first 34 and second 38 sides and first 42 and second 46 ends. A plurality of lamination support members 52 is provided. The support members 52 have top 56 and bottom 60 surfaces, first 62 and second 66 sides, first 70 and second 74 ends and a second predetermined thickness 78.

When the planar lower surface 22 of the first die board 18 is located upon the horizontal surface 14 and the lamination support members 52 are located upon the first curved upper surface 26 of the first die board 18 with the bottom surface 60 adjacent the second end 46 of the lamination support members 52 located upon the horizontal surface 14, the top surfaces 56 of the lamination support members 52 will reflect the first curved upper surface 26 of the first die board 18 above a point where the lamination support members 52 contact the first upper surface 26 and provide a curved surface 84 for laminating veneer portions(not shown).

In a variant of the invention, as illustrated in FIG. 23, a second die board 86 is provided. The second die board 86 has a planar lower surface 90, a second curved upper surface 94, a second predetermined thickness 98, first 102 and second 106 sides and first 110 and second 114 ends. When the planar lower surfaces 22, 90 of the first 18 and second 86 die boards are located upon the horizontal surface 14 and the lamination support members 52 are located upon the first 26 and second 94 curved upper surfaces of the first 18 and second 86 die boards, the top surfaces 56 of the lamination support members 52 will reflect the first 26 and second 94 curved upper surfaces of the first 18 and second 86 die boards and provide a curved surface 120 for laminating veneer portions (not shown).

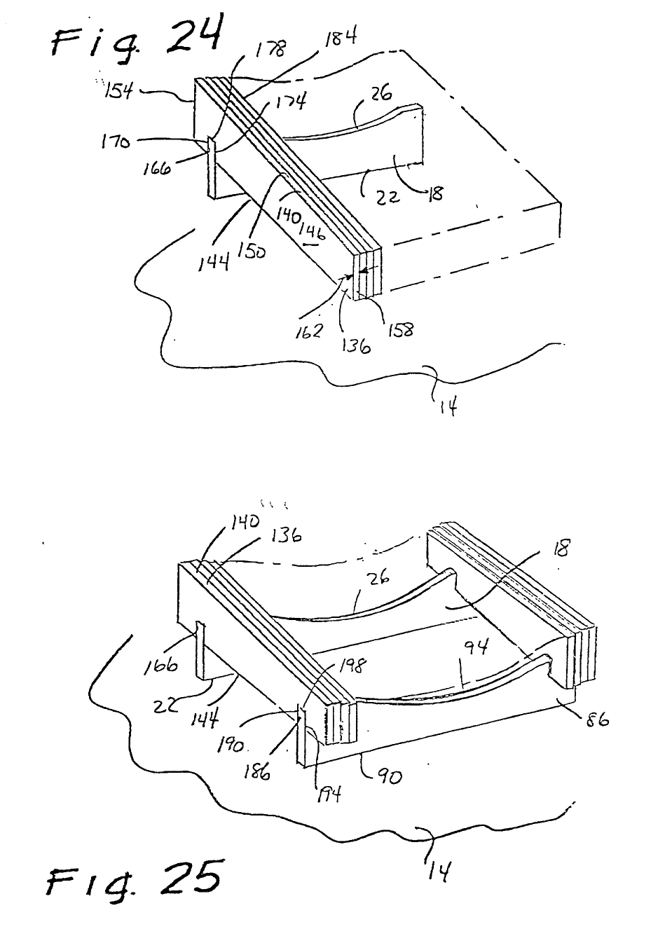

In still another variant, as illustrated in FIG. 24, a planar horizontal surface 14 is provided as is a first die board 18. The first die board 18 has a planar lower surface 22, a first curved upper surface 26, a first predetermined thickness 30, first 34 and second 38 sides and first 42 and second 46 ends. A plurality of lamination support members 136 is provided. The support members 136 have top 140 and bottom 144 surfaces, first 146 and second 150 sides, first 154 and second 158 ends, a fourth predetermined thickness 162 and a first notch 166 located upon the bottom surface 142 and spaced inwardly from the first end 154. The first notch 166 has first 170 and second 174 side walls and a first upper bearing surface 178. The first notch 166 is sized and shaped to fit slidably over the first predetermined thickness 30 of the first die board 18.

When the planar lower surface 22 of the first die board 18 is located upon the horizontal surface 14 and the first notches 166 of the lamination support members 136 are located upon the first curved upper surface 26 of the first die board 18 with the bottom surface 144 adjacent the second end 158 of the lamination support members 136 located upon the horizontal surface 14, the top surfaces 140 of the lamination support members 136 will reflect the first curved upper surface 26 of the first die board 18 above a point where the first notches 166 contact the first upper surface 26 and provide a curved surface 184 for laminating veneer portions.

In a final variant, as illustrated in FIG. 25, a second die board 86 is provided. The second die board 86 has a planar lower surface 90, a second curved upper surface 94, the first predetermined thickness 30, first 102 and second 106 sides and first 110 and second 114 ends. A second notch 186 is provided. The second notch 186 is located upon the bottom surface 144 and is spaced inwardly from the second end 150 of the lamination support members 136. The second notch 186 has first 190 and second 194 side walls and a second upper bearing surface 198. The second notch 186 is sized and shaped to fit slidably over the first predetermined thickness 30 of the second die board 86.

When the planar lower surfaces 22, 90 of the first 18 and second 86 die boards are located upon the horizontal surface 14 and the first 166 and second 186 notches of the lamination support members 136 are located upon the first 26 and second 94 curved upper surfaces of the first 18 and second 86 die boards, the top surfaces 140 of the lamination support members 136 will reflect the first 26 and second 94 curved upper surfaces of the first 18 and second 86 die boards and provide a curved surface 204 for laminating veneer portions.

The apparatus 10 and methods 270, 294, 298, 302, 306, 318 and 394 for forming curved laminations has been described with reference to particular embodiments. Other modifications and enhancements can be made without departing from the spirit and scope of the claims that follow.

1. An apparatus for forming curved laminations, comprising:
a planar horizontal surface;
a first die board, said first die board having a planar lower surface, a first curved upper surface, a first predetermined thickness, first and second sides and first and second ends;
said planar lower surface being disposed upon said planar horizontal surface;
a plurality of lamination support members, said support members having parallel top and bottom surfaces, first and second sides, first and second ends, a second predetermined thickness;
said bottom surfaces of said lamination support members being disposed upon said first curved upper surface of said first die board; and
whereby, when the planar lower surface of said first die board is disposed upon said horizontal surface and said lamination support members are disposed upon the first curved upper surface of the first die board with the bottom surface adjacent the second end of the lamination support members disposed upon the horizontal surface, the top surfaces of the lamination support members will reflect the first curved upper surface of the first die board above a point where the lamination support members contact said first upper surface and provide a curved surface for laminating veneer portions.

2. An apparatus for forming curved laminations as described in claim 1, further comprising:
a second die board, said second die board having a planar lower surface, a second curved upper surface, a third predetermined thickness, first and second sides and first and second ends;
said planar lower surface of said second die board being disposed upon said planar horizontal surface;
said bottom surfaces of said lamination support members being disposed upon said first and second curved upper surfaces of said first and second die boards; and
whereby, when the planar lower surfaces of said first and second die boards are disposed upon said horizontal surface and said lamination support members are disposed upon the first and second curved upper surfaces of said first and second die boards, the top surfaces of the lamination support members will reflect the first and second curved upper surfaces of the first and second die boards and provide a curved surface for laminating veneer portions.

3. An apparatus for forming curved laminations as Described in claim 1 wherein the lamination support members are cylindrical in cross-section.

4. An apparatus for forming curved laminations as Described in claim 1, wherein:
said lamination support members are substantially rectangular in cross-section;
said first side of said lamination support member including a rounded projecting tongue and said second side of said lamination support member including a mating rounded, receiving notch; and
whereby, adjacent lamination support members will fit more closely together while following the first curved upper surface of said first die board, thereby forming a smoother surface upon which veneer portions are laminated.

5. An apparatus for forming curved laminations as described in claim 1, further comprising:
an insulating sheet, said insulating sheet being formed of thin, flexible, resilient material;
said insulating sheet being disposed between top surfaces of the lamination support members and a lower surface of a veneer portion being laminated upon said lamination support members; and
whereby, when said insulating sheet is inserted between the lamination support members and the lower surface of a veneer portion indentations in a lamination resulting from contact with top surfaces of the lamination support members will be minimized.

6. An apparatus for forming curved laminations, comprising:
a planar horizontal surface;
a first die board, said first die board having a planar lower surface, a first curved upper surface, a first predetermined thickness, first and second sides and first and second ends;
said planar lower surface of said first die board being disposed upon said planar horizontal surface;
a plurality of lamination support members, said support members having parallel top and bottom surfaces, first and second sides, first and second ends, a fourth predetermined thickness and a first notch disposed upon said bottom surface and spaced inwardly from said first end;
said first notch having first and second side walls and a first upper bearing surface;
said first notch being sized and shaped to fit slidably over said first predetermined thickness of said first die board;
said first upper bearing surface being disposed upon said first curved upper surface; and
whereby, when the planar lower surface of said first die board is disposed upon said horizontal surface and said first notches of said lamination support members are disposed upon the first curved upper surface of the first die board with the bottom surface adjacent the second end of the lamination support members disposed upon the horizontal surface, the top surfaces of the lamination support members will reflect the first curved upper surface of the first die board above a point where the first notches contact said first upper surface and provide a curved surface for laminating veneer portions.

7. An apparatus for forming curved laminations as described in claim 6, further comprising:
a second die board, said second die board having a planar lower surface, a second curved upper surface, the first predetermined thickness, first and second sides and first and second ends;
said planar lower surface of said second die board being disposed upon said planar horizontal surface;
a second notch, said second notch being disposed upon said bottom surface and being spaced inwardly from the second end of said lamination support members;
said second notch having first and second side walls and a second upper bearing surface;
said second notch being sized and shaped to fit slidably over said first predetermined thickness of said second die board;
said second upper bearing surface being disposed upon said second curved upper surface; and
whereby, when the planar lower surfaces of said first and second die boards are disposed upon said horizontal surface and said first and second notches of said lamination support members are disposed upon the first and second curved upper surfaces of said first and second die boards, the top surfaces of the lamination support members will reflect the first and second curved upper surfaces of the first and second die boards and provide a curved surface for laminating veneer portions.

8. An apparatus for forming curved laminations as described in claim 6, further comprising:
an insulating sheet, said insulating sheet being formed of thin, flexible, resilient material;
said insulating sheet being disposed between top surfaces of the lamination support members and a lower surface of a veneer portion being laminated upon said lamination support members; and
whereby, when said insulating sheet is inserted between the lamination support members and the lower surface of a veneer portion indentations in a lamination resulting from contact with top surfaces of the lamination support members will be minimized.

9. An apparatus for forming curved laminations as described in claim 6, wherein:
said first upper bearing surface of said first notch including a downward facing curve;
said downward facing curve having its lowest point at a vertical centerline of said lamination support member; and
whereby, when said first notch of said lamination support members is disposed upon said first curved upper surface of said first die board, with the bottom surface adjacent the second end of the lamination support members disposed upon the horizontal surface, the top surfaces of the lamination support members will more accurately reflect the first curved upper surface of the first die board above the point where said downward facing curve of said first upper bearing surface of said first notch contacts said first curved upper surface and provide a curved surface for laminating veneer portions.

10. An apparatus for forming curved laminations as described in claim 7, wherein:
said first and second upper bearing surfaces of said first and second notches including downward facing curves;
said downward facing curves having their lowest points at a vertical centerline of said lamination support member; and
whereby, when said first and second notches of said lamination support members are disposed upon said first and second curved upper surfaces of said first and second die boards, the top surfaces of the lamination support members will more accurately reflect the first and second curved upper surfaces of the first and second die boards and provide a curved surface for laminating veneer portions.

11. An apparatus for forming curved laminations as described in claim 6, further comprising:
a series of closely spaced cuts extending orthogonally from said first side to said second side and from said top surface toward said bottom surface of said lamination support members;
said cuts permitting said top surfaces to assume a three-dimensional contoured configuration when a three-dimensional object having said configuration on an upper surface is placed between said horizontal surface and said bottom surface of said lamination support members; and
whereby, when said object causes said lamination support members to bend, a surface having compound curves will be formed for laminating veneer portions.

12. An apparatus for forming curved laminations as described in claim 6, wherein the first curved upper surface of the first die board includes an upward facing curve extending from the first side to the second side of said first die board.

13. An apparatus for forming curved laminations as described in claim 6, wherein the top surface of each lamination support member includes an upward facing curve extending from the first side to the second side of said member.

14. An apparatus for forming curved laminations as described in claim 6, wherein:
the first upper bearing surface of said first notch is formed as a portion of an orifice disposed at a first predetermined distance from the top surface of the lamination support member; and
the first and second side walls of said first notch extending upwardly from the bottom surface of said support member and intersecting a lower portion of a perimeter of said orifice.

15. An apparatus for forming curved laminations as described in claim 14, wherein:
the first upper bearing surface of said first notch includes a downward facing curve extending from the first side to the second side of said lamination support member; and
said downward facing curve having its lowest point at a vertical centerline of said lamination support member.

16. A method for forming curved laminations, comprising:
providing a planar horizontal surface;
preparing a first die board, said first die board having a planar lower surface, a first curved upper surface, a first predetermined thickness, first and second sides and first and second ends;
said first curved upper surface reflecting a desired curve for at least one end of a lamination;
providing a plurality of lamination support members, said support members having parallel top and bottom surfaces, first and second sides, first and second ends, a second predetermined thickness;
positioning the lower planar surface of said first die board upon the horizontal surface;
assembling said lamination support members upon said first die board and with the bottom surface adjacent the second end of the lamination support members disposed upon the horizontal surface;
providing an insulating sheet, said insulating sheet being formed of thin, flexible, resilient material and being designed to prevent indentations in a lamination resulting from contact with top surfaces of the lamination support members;
placing said insulating sheet upon the top surfaces of the lamination support members;
preparing at least two veneer portions, said veneer portions being sized and shaped to fit above the top surfaces of said lamination support members;
providing a glue layer between said veneer portions;
placing said veneer portions upon said insulating sheet;
applying pressure to an upper surface of a top veneer portion;
allowing said glue to dry; and
removing the laminated veneer portions from the insulating sheet.

17. A method for forming curved laminations, comprising:
providing a planar horizontal surface;
preparing a first die board, said first die board having a planar lower surface, a first curved upper surface, a first predetermined thickness, first and second sides and first and second ends;
said first curved upper surface reflecting a desired curve for at least one end of a lamination;
preparing a second die board, said second die board having a planar lower surface, a second curved upper surface, a third predetermined thickness, first and second sides and first and second ends;
said second curved upper surface reflecting a desired curve for at least one end of a lamination;
providing a plurality of lamination support members, said support members having parallel top and bottom surfaces, first and second sides, first and second ends, a second predetermined thickness;
positioning the lower planar surfaces of said first and second die boards upon the horizontal surface with the first die board parallel to the second die board, said first die board being spaced from the second die board;
assembling said lamination support members upon said first and second die boards;
providing an insulating sheet, said insulating sheet being formed of thin, flexible, resilient material and being designed to prevent indentations in a lamination resulting from contact with top surfaces of the lamination support members;
placing said insulating sheet upon the top surfaces of the lamination support members;
preparing at least two veneer portions, said veneer portions being sized and shaped to fit above the top surfaces of said lamination support members;
providing a glue layer between said veneer portions;
placing said veneer portions upon said insulating sheet;
applying pressure to an upper surface of a top veneer portion;
allowing said glue to dry; and
removing the laminated veneer portions from the insulating sheet.

18. A method for forming curved laminations, comprising:
providing a planar horizontal surface;
preparing a first die board, said first die board having a planar lower surface, a first curved upper surface, a first predetermined thickness, first and second sides and first and second ends;
said first curved upper surface reflecting a desired curve for at least one end of a lamination;
providing a plurality of lamination support members, said support members having parallel top and bottom surfaces, first and second sides, first and second ends, a fourth predetermined thickness and a first notch disposed upon said bottom surface and spaced inwardly from said first end;
said first notch having first and second side walls and a first upper bearing surface;
said first notch being sized and shaped to fit slidably over said first predetermined thickness of said first die board;
positioning the lower planar surface of said first die board upon the horizontal surface;
assembling said lamination support members upon said first die board with said first notches engaging said first curved upper surface of said first die board and with the bottom surface adjacent the second end of the lamination support members disposed upon the horizontal surface;
providing an insulating sheet, said insulating sheet being formed of thin, flexible, resilient material and being designed to prevent indentations in a lamination resulting from contact with top surfaces of the lamination support members;
placing said insulating sheet upon the top surfaces of the lamination support members;
preparing at least two veneer portions, said veneer portions being sized and shaped to fit above the top surfaces of said lamination support members;
providing a glue layer between said veneer portions;
placing said veneer portions upon said insulating sheet;
applying pressure to an upper surface of a top veneer portion;
allowing said glue to dry; and
removing the laminated veneer portions from the insulating sheet.

19. A method for forming curved laminations, comprising:
providing a planar horizontal surface;
preparing a first die board, said first die board having a planar lower surface, a first curved upper surface, a first predetermined thickness, first and second sides and first and second ends;
said first curved upper surface reflecting a desired curve for at least one end of a lamination;
preparing a second die board, said second die board having a planar lower surface, a second curved upper surface, said first predetermined thickness, first and second sides and first and second ends;
said second curved upper surface reflecting a desired curve for at least one end of a lamination;
providing a plurality of lamination support members, said support members having parallel top and bottom surfaces, first and second sides, first and second ends, a fourth predetermined thickness and first and second notches disposed upon said bottom surface and spaced inwardly from said first end and second end, respectively;
said first and second notches having first and second side walls and first and second upper bearing surfaces;
said first and second notches being sized and shaped to fit slidably over said first predetermined thickness of said first and second die boards;
positioning the lower planar surfaces of said first and second die boards upon the horizontal surface with the first die board parallel to the second die board, said first die board being spaced from the second die board by a distance separating said first notch from said second notch;
assembling said lamination support members upon said first and second die boards with said first and second notches engaging said first and second curved upper surfaces of said first and second die boards;
providing an insulating sheet, said insulating sheet being formed of thin, flexible, resilient material and being designed to prevent indentations in a lamination resulting from contact with top surfaces of the lamination support members;
placing said insulating sheet upon the top surfaces of the lamination support members;
preparing at least two veneer portions, said veneer portions being sized and shaped to fit above the top surfaces of said lamination support members;
providing a glue layer between said veneer portions;
placing said veneer portions upon said insulating sheet;
applying pressure to an upper surface of a top veneer portion;
allowing said glue to dry; and
removing the laminated veneer portions from the insulating sheet.

20. A method for forming curved laminations as described in claims 16-19, wherein pressure is applied to the upper surface of the top veneer portion by inserting the apparatus for forming curved laminations together with the veneer portions with interleaved glue layer disposed upon the insulating sheet, disposed upon the top surfaces of the lamination support members, into a heavy duty, airtight plastic bag, sealing the bag and evacuating the air from the bag, thereby allowing atmospheric pressure to conform the veneer portions to the insulating sheet and the top surface of the lamination support members.

21. An apparatus for forming curved laminations, comprising:
a desired lamination profile, said profile including a planar baseline, and an upper curve;
said baseline having a first end, a second end, and being comprised of a series of equal-sized increments;
said upper curve, defining a height above said baseline for each increment of the baseline from said first end to said second end;
a plurality of adjacent lamination support members, said support members having parallel top and bottom surfaces, first and second sides, first and second ends, a fifth predetermined thickness equal to said equal-sized increment;
each of said adjacent lamination support members having a height equal to the height of the upper curve of the desired lamination profile above the baseline for one of the equal-sized increments;
means for maintaining said adjacent lamination support members in parallel alignment to one another, thereby yielding a curved surface defined by the adjacent top surfaces of said adjacent lamination support members, said curved surface being suitable for laminating veneer portions.

22. A method for forming curved laminations, comprising:
developing a desired lamination profile, said profile including a planar baseline, and an upper curve;
said baseline having a first end, a second end, and being comprised of a series of equal-sized increments;
said upper curve, defining a height above said baseline for each increment of the baseline from said first end to said second end;
providing a plurality of adjacent lamination support members, said support members having parallel top and bottom surfaces, first and second sides, first and second ends, a fifth predetermined thickness equal to said equal-sized increment;
each of said adjacent lamination support members having a height equal to the height of the upper curve of the desired lamination profile above the baseline for one of the equal-sized increments;
maintaining said adjacent lamination support members in parallel alignment to one another, thereby yielding a curved surface defined by the adjacent top surfaces of said adjacent lamination support members, said curved surface being suitable for laminating veneer portions;
providing an insulating sheet, said insulating sheet being formed of thin, flexible, resilient material and being designed to prevent indentations in a lamination resulting from contact with top surfaces of the adjacent lamination support members;
placing said insulating sheet upon the top surfaces of the adjacent lamination support members;
preparing at least two veneer portions, said veneer portions being sized and shaped to fit above the top surfaces of said adjacent lamination support members;
providing a glue layer between said veneer portions;
placing said veneer portions upon said insulating sheet;
applying pressure to an upper surface of a top veneer portion;
allowing said glue to dry; and
removing the laminated veneer portions from the insulating sheet.

23. An apparatus for forming curved laminations, comprising:
a planar horizontal surface;
a first die board, said first die board having a planar lower surface, a first curved upper surface, a first predetermined thickness, first and second sides and first and second ends;
said planar lower surface being disposed upon said planar horizontal surface;
a plurality of lamination support members, said support members having top and bottom surfaces, first and second sides, first and second ends, a second predetermined thickness;
said bottom surfaces of said lamination support members being disposed upon said first curved upper surface of said first die board; and
whereby, when the planar lower surface of said first die board is disposed upon said horizontal surface and said lamination support members are disposed upon the first curved upper surface of the first die board with the bottom surface adjacent the second end of the lamination support members disposed upon the horizontal surface, the top surfaces of the lamination support members will reflect the first curved upper surface of the first die board above a point where the lamination support members contact said first upper surface and provide a curved surface for laminating veneer portions.

24. An apparatus for forming curved laminations as described in claim 23, further comprising:
a second die board, said second die board having a planar lower surface, a second curved upper surface, a third predetermined thickness, first and second sides and first and second ends;
said planar lower surface of said second die board being disposed upon said planar horizontal surface;
said bottom surfaces of said lamination support members being disposed upon said first and second curved upper surfaces of said first and second die boards; and
whereby, when the planar lower surfaces of said first and second die boards are disposed upon said horizontal surface and said lamination support members are disposed upon the first and second curved upper surfaces of said first and second die boards, the top surfaces of the lamination support members will reflect the first and second curved upper surfaces of the first and second die boards and provide a curved surface for laminating veneer portions.

25. An apparatus for forming curved laminations, comprising:
a planar horizontal surface;
a first die board, said first die board having a planar lower surface, a first curved upper surface, a first predetermined thickness, first and second sides and first and second ends;
said planar lower surface of said first die board being disposed upon said planar horizontal surface;
a plurality of lamination support members, said support members having top and bottom surfaces, first and second sides, first and second ends, a fourth predetermined thickness and a first notch disposed upon said bottom surface and spaced inwardly from said first end;
said first notch having first and second side walls and a first upper bearing surface;
said first notch being sized and shaped to fit slidably over said first predetermined thickness of said first die board;
said first upper bearing surface being disposed upon said first curved upper surface; and
whereby, when the planar lower surface of said first die board is disposed upon said horizontal surface and said first notches of said lamination support members are disposed upon the first curved upper surface of the first die board with the bottom surface adjacent the second end of the lamination support members disposed upon the horizontal surface, the top surfaces of the lamination support members will reflect the first curved upper surface of the first die board above a point where the first notches contact said first upper surface and provide a curved surface for laminating veneer portions.

26. An apparatus for forming curved laminations as described in claim 25, further comprising:
a second die board, said second die board having a planar lower surface, a second curved upper surface, the first predetermined thickness, first and second sides and first and second ends;
said planar lower surface of said second die board being disposed upon said planar horizontal surface;
a second notch, said second notch being disposed upon said bottom surface and being spaced inwardly from the second end of said lamination support members;
said second notch having first and second side walls and a second upper bearing surface;
said second notch being sized and shaped to fit slidably over said first predetermined thickness of said second die board;
said second upper bearing surface being disposed upon said second curved upper surface; and
whereby, when the planar lower surfaces of said first and second die boards are disposed upon said horizontal surface and said first and second notches of said lamination support members are disposed upon the first and second curved upper surfaces of said first and second die boards, the top surfaces of the lamination support members will reflect the first and second curved upper surfaces of the first and second die boards and provide a curved surface for laminating veneer portions.
